(19) United States
(12) Patent Application Publication
(10) Pub. No.: US 2017/0142788 A1
(43) Pub. Date: May 18, 2017

(54) ILLUMINATION DEVICE

(71) Applicant: OSRAM GmbH, Munich (DE)

(72) Inventor: Yang Hu, Shanghai (CN)

(21) Appl. No.: 15/319,409

(22) PCT Filed: Apr. 30, 2015
(86) PCT No.: PCT/EP2015/059552

§ 371 Date: Dec. 16, 2016

(30) Foreign Application Priority Data
Jun. 19, 2014 (CN) 201410277067.X

(51) Int. Cl. H05B 33/08

(52) U.S. Cl. CPC H05B 33/0815; H05B 33/083; H05B 33/0842

(57) ABSTRACT

Various embodiments may relate to an illumination device that includes a rectifier unit connected to a power supply and at least one illumination unit connected to the rectifier unit via a buck circuit unit, wherein the illumination device further includes a main control unit connected with the buck circuit unit and the illumination unit, respectively, wherein the main control unit is configured to control, according to change of an input voltage from the rectifier unit, an input current from the rectifier unit to selectively flow through a lighting element of the illumination unit so as to adjust a total forward voltage of the lighting elements, and when the input voltage exceeds the total forward voltage, the buck circuit unit reduces the voltage across the illumination unit and enables the illumination device to enter into a buck state.

### RELATED APPLICATIONS

The present application is a national stage entry according to 35 U.S.C. §371 of PCT application No.: PCT/EP2015/059552 filed on Apr. 30, 2015, which claims priority from Chinese application No.: 201410277067.X filed on Jun. 19, 2014, and is incorporated herein by reference in its entirety.

### TECHNICAL FIELD

Various embodiments generally relate to an illumination device.

### BACKGROUND

The buck converter generally used for driving LEDs is a simply designed and low-cost solution. However, the power factor (PF) of the buck converter usually used for offline application is lower since an electrolytic capacitor is needed in the input side. With the increasing and popular LED application for high power illumination devices, the improvement on the power factor becomes more and more important and draws more attraction.

One solution in the related art to increase the power factor of the drive circuit is to use a two-stage drive structure, wherein the first stage of the drive circuit is usually configured as a boost converter for power factor correction and further for providing a constant voltage, and the second stage of the drive circuit is configured as a buck converter to control a current of an LED string. The two-stage drive circuit can provide a high power factor for an LED illumination device, while this drive circuit is expensive and has low drive efficiency.

Another solution in the related art provides a single-stage buck converter with power factor correction. This buck converter does not have an electrolytic capacitor in the input part, and an IC controller thereof controls an input current to make it change in a trapezoid shape. Although this buck converter can provide the buck function of power factor correction for the LED illumination device, the power factor thereof is affected by a forward voltage of the LED string, that is, the bigger the forward voltage of the LEDs is, the lower the power factor of the buck converter is, thereby, such buck converter cannot be used for high-power LEDs. Besides, in this buck converter, since no electrolytic capacitor is provided in the input part, the output current for driving the LEDs has an obvious ripple current which will become higher as the forward voltage of the LED string increases.

### SUMMARY

In order to solve the above technical problems, the present disclosure provides a novel illumination device. The illumination device according to the present disclosure has a simple structure and a low cost, and has an extremely low ripple current due to the configuration of a relatively capacitance. Moreover, compared with the switch mode converter, the illumination device according to the present disclosure is not subjected to the electromagnetic interference EMI issue. Besides, the illumination device according to the present disclosure has a novel single-stage buck converter with power factor correction, and on this basis, a function is further added such that this illumination device can expand the conduction angle of an input current, i.e., increase the power factor, reduce the harmonic wave, and also can eliminate the ripple of 100 Hz/120 Hz, which eliminates the low-frequency flicker for the output light.

One object of the present disclosure is accomplished via an illumination device that includes a rectifier unit connected to a power supply and at least one illumination unit connected to the rectifier unit via a buck circuit unit, wherein the illumination device further includes a main control unit connected with the buck circuit unit and the illumination unit, respectively, wherein the main control unit is configured to control, according to change of an input voltage from the illumination unit, an input current from the rectifier unit to selectively flow through a lighting element of the illumination unit so as to adjust a total forward voltage of the lighting element, and when the input voltage exceeds the total forward voltage, the buck circuit unit reduces the voltage across the illumination unit and enables the illumination device to enter into a buck state. The illumination device according to the present disclosure thereby has a single-stage buck converter based on power factor correction preferably for an LED illumination device, by allowing the input current to selectively flow through the lighting elements, a sum of the forward voltages of the lighting elements through which the input current flows also will correspondingly change, thus, it is possible to expand a conduction angle of the input current, and therefore the power factor of the buck converter can be increased.

According to various embodiments, the main control unit controls the illumination units to selectively short-circuit the respective lighting elements to adjust the total forward voltage of the lighting elements. The illumination units are controlled in a simple and highly effective short-circuit manner to short-circuit or bypass the lighting elements such that the input current from the rectifier unit can selectively pass through or not pass through the lighting elements of the illumination units, as a result, the sum of the forward voltages of the lighting elements through which the input current flows can correspondingly change.

According to various embodiments, the input current flows through all of the lighting elements when the illumination device enters a buck state. After all the lighting elements are powered by the input current from the rectifier unit to work properly, at this point, the input voltage from the rectifier unit exceeds the forward voltage of all the lighting elements of the illumination units arranged, thereafter, the buck circuit unit enables the illumination device to enter into a buck state, which provides the possibility of expanding the conduction angle of the input current.

The illumination unit may further include a first switch, wherein the first switch is in parallel connection with a corresponding lighting element. When the first switch in parallel connection with the lighting element is closed to turn on, the first switch forms short-circuit connection of this lighting element, that is, the input current flows through the first switch but not the lighting element. Correspondingly, when the first switch is open to turn off, the input current directly flows through the lighting element.

The buck circuit unit may include a second switch, and the main control unit can form together with the second switch a linear current-limiting unit for the illumination unit. This second switch may be connected in series with the lighting element, thus, the second switch can limit the current flowing through the lighting element when both the second switch and the lighting element are turned on. Besides, the second switch can achieve the power factor correction of the illumination device as a part of the buck circuit unit.

Advantageously, the main control unit switches the second switch with a PWM signal. According to such design, the main control unit can advantageously limit the current flowing through the lighting elements.

The main control unit may include a sub controller for controlling switch of the first switch and the second switch. The sub controller can simultaneously or separately control the first switch and the second switch so that the main control unit can enable the input current to selectively flow through the lighting elements in parallel connection with respective first switches.

According to various embodiments, the illumination unit further includes a capacitor and a first diode, and the first diode is connected in series upstream of a parallel connection formed by the capacitor and a corresponding lighting element. The capacitor can supply power to the lighting element in parallel connection therewith in a manner of releasing electrical energy stored in a situation that the input current does not directly flow through the lighting element.

According to various embodiments, a control electrode of the first switch and a control electrode of the second switch are connected to an output control terminal of the sub controller, respectively, and an operating electrode of the first switch is connected to the anode of the first diode, the cathode of the first diode is connected to one terminal of the lighting element, and a reference electrode of the first switch is connected to the other terminal of the lighting element, an operating electrode of the second switch is connected to the output terminal of the illumination unit, a reference electrode of the second switch is grounded. The main control unit controls the switch of the first switch and the second switch by transmitting a control signal to respective control electrodes of the first switch and the second switch.

The buck circuit unit further may include an inductor and a second diode, wherein one terminal of the inductor is connected to the node between the cathode of the second diode and the output terminal of the rectifier unit, the other terminal of the inductor is connected to the input terminal of the illumination unit, and the anode of the second diode is connected to the operating electrode of the second switch. In this way, the second switch can further form serial connection with the inductor and the second diode which are connected in parallel with each other, thereby the main control unit can for instance control the buck circuit unit by controlling the second switch.

The first switch and the second switch may be respectively configured as MOSFETs or bipolar transistors.

The sub controller may be configured as an operational amplifier. As a simple and low-cost electrical element, the operational amplifier can effectively, in a manner as simple as possible, control the first switch and the second switch connected therewith, respectively.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a functional block diagram of an illumination device according to the present disclosure;

FIG. 2 shows a schematic diagram of a circuit structure of the illumination device according to the present disclosure; and

FIG. 3 shows a schematic diagram of changes of an input voltage from a rectifier unit according to the present disclosure.

### DETAILED DESCRIPTION

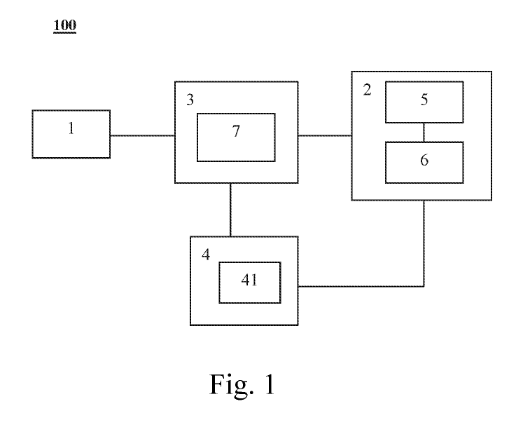

FIG. 1 shows a functional block diagram of an illumination device 100 according to the present disclosure. The illumination device 100 according to the present disclosure includes a rectifier unit 1 connected to a power supply, a buck circuit unit 3 connected to an input of the rectifier unit 1, and an illumination unit 2 connected to this buck circuit unit 3, besides, the illumination device 100 further includes a main control unit 4 for controlling the buck circuit unit 3 and the illumination unit 2, respectively, wherein the main control unit 4 further includes a sub controller 41 for directly controlling a first switch 6 and a second switch 7 which are arranged in the buck circuit unit 3 and the illumination unit 2. Lighting elements 5 provided in the illumination unit 2 are selectively controlled by the main control unit 4, that is, the main control unit 4 allows an input current from the rectifier unit 1 to correspondingly flow through the lighting elements 5 by controlling turn-on or turn-off of the first switches 6 connected with the respective lighting elements 5, wherein the lighting elements 5 are preferably configured as LEDs. The illumination device 100 according to the present disclosure can have a buck function with power factor correction provided by the buck circuit unit 3, and also can selectively control the illumination unit 2 by means of the main control unit 4 so as to expand the conduction angle of the input current. The illumination device 100 according to the present disclosure can operate in a discontinuous conduction mode (DCM), a continuous conduction mode (CCM), or a critical conduction mode (CRM) corresponding to the buck converter and the control mode may be current mode control or voltage mode control.

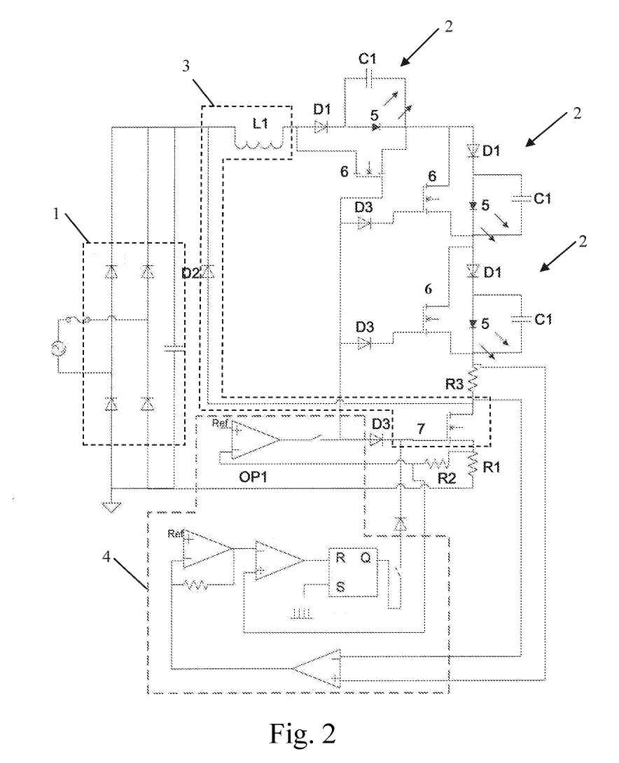

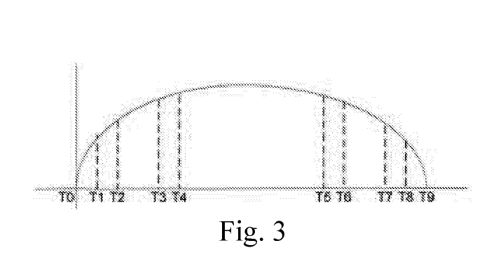

FIG. 2 shows a schematic diagram of a circuit structure of the illumination device 100 according to the present invention. The rectifier unit 1 of the illumination device 100 according to the present disclosure includes a filter capacitor and a rectifier bridge formed by a plurality of diodes so as to provide an input electrical signal rectified, wherein this input electrical signal may preferably have a waveform of a positive half of a sine wave obtained from rectification of a standard sine wave, e.g., the exemplary waveform as shown in FIG. 3. The buck circuit unit 3, connected downstream of the rectifier unit 1, is configured to includes an inductor L1, a second diode D2, and a second switch 7, wherein the inductor L1 and the illumination units 2, after connected in series, are connected in parallel with the second diode D2, the second switch 7 is further connected in series with parallel connection formed by the inductor L1 and the second diode D2. Although three illumination units 2 are exemplarily shown in FIG. 2, one or more illumination units 2 may be provided in practice.

Furthermore, the illumination units 2 may be preferably connected in series as shown in FIG. 2, and also can be connected in parallel and/or in series to combine according to practical application demands. Respective illumination unit 2 is preferably configured to include a first diode D1, a first switch 6, a lighting element 5, and a capacitor C1, wherein the first switch 6 is preferably configured as a MOSFET transistor and configured to have a gate thereof connected to the main control unit 4, and a source and a drain connected to both ends of a circuit structure formed by the first diode D1 and the lighting element 5. The first diode D1 further forms a serial connection with parallel connection formed by the capacitor C1 and the corresponding lighting element 5, and the first switch 6 is advantageously configured to form parallel connection with a circuit structure formed by the first diode D1, the capacitor C1, and the lighting element 5 so as to be capable of short-circuiting the lighting element 5 by the first switch 6 when the first switch 6 is conducted.

FIG. 2 further shows the main control unit 4 connected to the buck circuit unit 3 and the illumination units 2. This main control unit 4 may be preferably configured as a microprocessor or a similar IC controller. The main control unit 4 includes a sub controller 41 configured as an operational amplifier OP1 which has an input connected, via the third diodes D3, to gate electrodes of MOSFET transistors as the first switches 6 and the second switch 7, respectively, wherein the MOSFET transistors herein also maybe substituted by bipolar transistors or similar electric parts and the object of the present disclosure is realized. The operational amplifier OP1 as a linear regulator can control the first switches and the second switch 7 connected therewith. Besides, this main control unit 4 also may include a buck controller for controlling the buck circuit unit 3. This buck controller may include a plurality of operational amplifiers or similar electric parts. Furthermore, the illumination device 100 further includes a first resistor R1, a second resistor R2, and a third resistor R3. The first resistor R1 has one end connected with a source of a MOSFET transistor as the second switch 7, and the other end connected to the ground so that the source of the second switch 7 is grounded via the first resistor R1. This source is connected to one input of the operational amplifier OP1 via the second resistor R2. A drain of the second switch 7 is connected to the lighting elements 5 via the third resistor R3. In this way, according to the example of the present disclosure, the first resistor R1 and the third resistor R3 can limit a current flowing through the lighting elements 5 when the second switch 7 is conducted, and forms, combined with the main control unit 4, a linear current-limiting unit.

It should be noted that the circuit structure as shown in FIG. 2 is merely exemplary, and a person skilled in the art could know, according to different practical design demands, that the first switches 6 may be for instance configured to connect in parallel merely with some of the lighting elements 5, this is, not every lighting element 5 is provided with a first switch 6 in parallel connection therewith.

FIG. 3 shows a schematic diagram of changes of an input voltage from the rectifier unit 1 according to the present disclosure.

According to the situation of changes of the input voltage from the rectifier unit 1, the illumination device 100 of the present disclosure has the following multiple operation states. During the periods of T0 to T1 and T8 to T9, the input voltage is lower than the forward voltage of one of the lighting elements 5, at this point no input current flows through this lighting element 5, but a current for normal operation of this lighting element 5 may come from the capacitors Cl in parallel connection with respective lighting elements 5. During the periods of T1 to T2 and T7 to T8, the input voltage is higher than the forward voltage of one of the lighting element 5, the first switch 6 is controlled to turn on by the main control unit 4, and the lighting element 5 is short-circuited by the first switch 6 through which the input current flows. During the periods of T2 to T3 and T6 to T7, the input voltage is higher than a sum of the effective forward voltages of some of the lighting elements 5, the main control unit 4 controls to turnoff some of the first switches 6, while controls the remaining first switches 6 to still turn on, thereby the input current selectively flows through the lighting elements 5 in parallel connection with the first switches 6 which are already turned off, moreover, the input current also flows through the capacitors in parallel connection with these lighting elements 5 and charges the capacitors, while the capacitors still in parallel connection with the first switches 6 still turned-on discharge electricity to the corresponding lighting elements 5. The input current during this period is controlled by the second switch 7. During the periods of T3 to T4 and T5 to T6, the input voltage exceeds a sum of the effective forward voltages of all the lighting elements 5 provided in the illumination device 100, thereby the main control unit 4 controls to turn off all the first switches 6, the input current flows through all the lighting elements 5, and the second switch 7 still limits this input current, wherein the duration of T3 to T4 and T5 to T6 may be short or long according to the buck operational state of the illumination device. During the period of T4 to T5, the input voltage has exceeded the sum of the effective forward voltages of all of the lighting elements 5, the main control unit 4 controls the buck circuit unit 3 to reduce the voltage across the illumination unit such that the buck circuit unit 3 operates as a buck converter or a buck driver, and the illumination device 100 enters into a buck state, at this point the main control unit 4 may provide a PWM signal to a control electrode of the second switch 7 to limit the current flowing through the lighting elements 5.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An illumination device comprising:
a rectifier unit connected to a power supply and
at least one illumination unit connected to the rectifier unit via a buck circuit unit,
wherein the illumination device further comprises a main control unit connected to the buck circuit unit and the illumination unit, respectively, wherein the main control unit is configured to control, according to change of an input voltage from the rectifier unit, an input current from the rectifier unit to selectively flow through a lighting element of the illumination unit so as to adjust a total forward voltage of the lighting elements, and when the input voltage exceeds the total forward voltage, the buck circuit unit reduces the voltage across the illumination unit and enables the illumination device to enter into a buck state.

2. The illumination device according to claim 1, wherein the main control unit controls the illumination unit to selectively short-circuit the respective lighting element to adjust the total forward voltage of the lighting elements.

3. The illumination device according to claim 1, wherein the input current flows through all of the lighting elements when the illumination device enters the buck state.

4. The illumination device according to claim 1, wherein the illumination unit further comprises a first switch, wherein the first switch is in parallel connection with a corresponding lighting element.

5. The illumination device according to claim 4, wherein the buck circuit unit comprises a second switch, and the main control unit forms together with the second switch a linear current-limiting unit for the illumination unit.

6. The illumination device according to claim 5, wherein the main control unit switches the second switch with a PWM signal.

7. The illumination device according to claim 5, wherein the main control unit comprises a sub controller for controlling switch of the first switch and the second switch.

8. The illumination device according to claim 7, wherein the illumination unit further comprises a capacitor and a first diode, and the first diode is connected in series upstream of a parallel connection formed by the capacitor and a corresponding lighting element.

9. The illumination device according to claim 8, wherein a control electrode of the first switch and a control electrode of the second switch are connected to an output control terminal of the sub controller, respectively, and an operating electrode of the first switch is connected to the anode of the first diode, the cathode of the first diode is connected to one terminal of the lighting element, and a reference electrode of the first switch is connected to the other terminal of the lighting element, an operating electrode of the second switch is connected to the output terminal of the illumination unit, a reference electrode of the second switch is grounded.

10. The illumination device according to claim 9, wherein the buck circuit unit further comprises an inductor and a second diode, wherein one terminal of the inductor is connected to the node between the cathode of the second diode and the output terminal of the rectifier unit, the other terminal of the inductor is connected to the input terminal of the illumination unit, and the anode of the second diode is connected to the operating electrode of the second switch.

11. The illumination device according to claim 9, wherein the first switch and the second switch are respectively configured as MOSFETs or bipolar transistors.

12. The illumination device according to claim 9, characterized in that wherein the sub controller is configured as an operational amplifier.

13. The illumination device according to claim 2, wherein the illumination unit further comprises a first switch, wherein the first switch is in parallel connection with a corresponding lighting element.

14. The illumination device according to claim 3, wherein the illumination unit further comprises a first switch, wherein the first switch is in parallel connection with a corresponding lighting element.
